(19) United States
(12) Patent Application Publication
(10) Pub. No.: US 2012/0090313 A1
(43) Pub. Date: Apr. 19, 2012

(54) Device for floating wave power plant

(75) Inventor: Nils Severin Myklebust, Trondheim (NO)

(73) Assignee: PONTOON POWER AS, Stavanger (NO)

(21) Appl. No.: 13/262,235

(22) PCT Filed: Mar. 31, 2010
(86) PCT No.: PCT/NO10/00125

§ 371 Date: Dec. 23, 2011

(30) Foreign Application Priority Data
Apr. 3, 2009 (NO) 20091383

(51) Int. Cl. F03B 13/18

(52) U.S. Cl. 60/505

(57) ABSTRACT

The present invention pertains to a device of a floating wave power plant. More precisely, the invention pertains to a submerged frame structure with an attached ballast body as an element in a floating wave power plant. The frame structure and thereby the wave power plant is preferably anchored to the sea bottom. The wave power plant comprise several pumping cylinders (4) connected to buoyancy elements (5) via connecting elements, which buoyancy elements (5) under the action from waves move the pumping cylinders in full or partial pumping strokes. Furthermore, the pumping cylinders are connected to the submerged frame structure (3), and said frame structure is connected to one or more ballast bodies via a number of connecting elements (2).

The present invention pertains to a device for a floating wave power plant. More precisely, the invention pertains to a submerged frame structure with a ballast element being an element in a floating wave power plant. The frame structure and thereby the wave power plant is preferably anchored to the seabed.

The wave power plant is presumed to absorb energy from the sea waves by means of a number of buoyancy elements. Each buoyancy element is connected to a pumping cylinder, and when the waves make the buoyancy element rise and descend, the buoyancy element's mechanical work is transformed into pressure energy in the flowing medium delivered by the pumping cylinder to a collecting pipe system. Each buoyancy element is connected to the frame structure, preferably at the cylinder's lower end, via a bearing which allows the cylinder's longitudinal axis to rotate freely to adjust to the buoyancy element's direction of movement when the direction of the buoyancy element's lifting force deviates from the vertical direction. The pressure energy of the flowing medium can be transformed into electrical energy in a power aggregate comprising a turbine and an electrical generator.

A pumping cylinder with a first and a second end, which at one end is connected to a buoyancy element for the purpose of producing work, as herein described, must be restrained by a reaction force in the cylinder's longitudinal direction at the second end, the reaction force being equal to the force from the buoyancy element, corrected for buoyancy and mass forces of the buoyancy element itself. Defined as work per unit time, the power absorbed by the pumping cylinder is at any time equal to the force in the piston rod multiplied with the velocity of the piston relative to the cylinder. The power exerted by the pumping cylinder is reduced if the cylinder's connection point in the frame structure yields to the force from the buoyancy element, because the piston's velocity relative to the cylinder is then reduced. If the cylinder's connection point yields to the buoyancy element's force, it will also take some time before the cylinder is back in its original position, and if the connection point is not back in its original position at the start of the next wave cycle, the cylinder's ability to exert work will be further reduced in that wave cycle. In order for the pumping cylinder to be able to produce as much work as possible, its connection point to the frame structure should ideally be at rest, and in practical terms that means that the movement of the cylinder's connection point should be small compared to the movement of the buoyancy element.

I addition to creating a virtually stationary restraint against the forces from the buoyancy elements, the challenge is also to make a robust structure without being too expensive to build, and at the same time being able to convert enough energy from the waves to give the power plant an acceptable economic situation.

From prior art pertaining to buoyancy elements connected to frames reference is made to WO/0196738 showing a frame kept floating by floats which do not exert power themselves. A separate power producing float is connected to a pumping cylinder on the frame structure and is thereby able to exert pump work.

Further reference is made to a solution for arranging floats on a floating structure utilized on Fred Olsen's floating test rig “Buldra”, as described in WO9004718 and WO2004113718.

Further reference is made to U.S. Pat. No. 7,444,811 where the buoyancy elements' movement converts mechanical energy directly to electrical energy by means of linear generators.

A solution where the frame structure is carried by the working floats alone is described in U.S. Pat. No. 4,742,241.

Furthermore a solution for providing a restraint for a singular buoyancy element is described in WO2006126887, showing a structure resembling an umbrella turned upside down. This body will exert a significant resistance to the movement in the water due to of its large exposed surface to the mass of water, but it will yield to some extent depending of its size relative to the size of the attached buoyancy element.

A further solution is to let the pumping cylinders have fixed connections to the seabed. This will be a viable solution where the water depth is limited. It may however also be interesting to extract energy from sea waves where the water depth is greater.

A solution where the buoyancy elements are not held down by pumping cylinders but rather are linked together is used in the wave power plant Pelamis. Several oblong floating elements are interconnected by special link joints where hydraulic pumps are placed. The pumps are driven by the forces and the movements that occur when this “sea snake” is moving in the waves. A similar principle is employed in NO326156 where the absorption of energy in the links is transformed directly into electrical energy as each joint is connected to a rotor that moves relative to a stator.

With the abovementioned challenges and known solutions in mind, the present invention brings forward a device for a floating wave power plant comprising a number of pumping cylinders connected to a number of buoyancy elements via connecting elements which buoyancy elements move the pistons of the pumping cylinders in full or partial pump strokes under the influence of waves. The invention is characterized by the feature that the pumping cylinders are connected to a submerged frame structure, and that the frame structure is connected to one or more ballast bodies via a number of connecting elements.

The connecting elements may be different forms of cable, wire, chain or similar, which mainly may be flexible with respect to bending but which should have low elasticity with respect to tension forces.

In the preferred embodiment of the invention, the mass of the ballast body and the and physical dimension of the frame structure are made to suit the number of buoyancy elements and the buoyancy of the buoyancy elements such that the frame structure obtains an inertia with respect to linear acceleration and angular acceleration. Furthermore the average value of the lifting force of the combined buoyancy elements will vary less over time than the average value of the lifting force of the individual buoyancy elements over time. As a result the frame structure provides a virtually stationary underwater downhaul for the pumping cylinders.

The wave power plant absorbs energy from the waves by means of a greater number of buoyancy elements. Each buoyancy element is connected to a pumping cylinder, and when the buoyancy element is lifted or lowered by the waves, the buoyancy elements' mechanical work is transformed into pressure energy in a liquid, delivered by the pumping cylinder to a collecting pipe system.

In different embodiments the lower end of each cylinder may be connected to the frame structure in different ways, e.g. by a fixed connection or by a bearing that allows the cylinder's longitudinal axis to pivot when the buoyancy element's force deviates in direction from the vertical.

The pressure energy of the flowing medium is transformed into electrical energy in a power aggregate comprising a turbine and an electrical generator. If the power aggregate is placed on the frame structure, it may be placed in a generator housing being virtually naturally buoyant, and may be connected to the frame structure in such a way that it may be easily disconnected and brought to shore or to a floating vessel for overhaul.

The frame structure keeps the holding brackets for the cylinders in place relative to each other in the horizontal plane. In addition, the frame structure keeps the said holding brackets virtually at rest in the vertical direction in spite of the variation in force acting on the frame structure from each buoyancy element. The virtually stationary restraint for the buoyancy elements' pumping cylinders is achieved through having several buoyancy elements being in different phase of the work cycle connected to via the frame structure to a common ballast body with a great mass that gives the system a large inertia.

The invention seeks to utilize the fact that a floating construction having sufficiently great mass, stiffness and many buoyancy elements that are spread with a large spacing between them compared to the lengths of passing waves will be virtually at rest and will to only a small degree be influenced by the variable buoyancy force that the waves exert on each individual buoyancy element.

Furthermore, this solution seeks to minimize material weight in the elements exposed to structural loads through letting the vertical force from each buoyancy element be transferred as directly as possible into tension in the respective connecting element like an oblique cable going down to the ballast body. The purpose of the ballast body is to give the whole construction the desired inertia and also to give the buoyancy elements the desired downward acting load so that the buoyancy elements' pumping power will be optimal.

Preferably the buoyancy elements are arranged with a mutual horizontal spacing whereby the buoyancy elements due to their mutual horizontal spacing will at any time be in different phases of the force cycles created by the passing waves. The total buoyancy force from the buoyancy elements will thus be smoothed out and will be more equal to the average buoyancy the higher the number of buoyancy elements is and the greater horizontal length is over which the buoyancy elements are spread out by means of the frame structure. From this follows that the centre of gravity for the whole construction's mass has the ability to be virtually at rest with respect to vertical translational movement, heave, an ability which increases by the number of buoyancy elements and the size of the frame structure.

The size of the frame structure, seen in the propagating direction of the waves, should with regard to heave be at least one wavelength.

In order for the construction to be virtually at rest in spite of a sea state with waves, it should in addition to having small heave movement also have small angular movements like pitching and rolling. The solution is to give the frame structure a sufficiently large horizontal dimension so that the moments of the buoyancy elements about the centre of gravity more or less balance each other at any time. This is achieved to an acceptable degree when the frame structure's size, seen in the propagating direction of the waves, is at least two wavelengths. If the horizontal size is increased, this will increase the construction's ability to stay virtually at rest.

Optimal power production from the buoyancy elements will depend on the degree of ballasting and among others the control of the pressure levels in the pumped medium and the control of the attached turbine. It is assumed that the maximal power production at a given sea state is achieved when each of the buoyancy elements in still water is loaded down with a tension force that is approximately 50% of the buoyancy element's maximal net lifting capacity. The maximal static net lifting capacity is equal to the maximum buoyancy force of a fully submerged buoyancy element minus the weight the buoyancy element. The total submerged weight of the frame structure and the ballast body should be chosen with the purpose of obtaining maximal power production, and from this the optimal weight of the ballast body can be calculated.

In further embodiments at least one of the ballast bodies can be connected to anchoring devices at the sea bottom via anchoring lines.

Furthermore, the sea bottom anchored ballast body can be provided with a connecting body which is further connected to the anchor lines, which connecting body is provided with a revolving mount such that the frame structure can revolve about a substantially vertical axis. By being able to revolve in the horizontal plane, the wave power-plant can optimize its power production as the waves change direction of propagation, and can give the wave power plant a great enough dimension in the direction of wave propagating to minimize angular accelerations of the construction. The longitudinal axis of the structure should preferably be at an angle to the propagating direction of the waves in order not to be too much in the lee of each other.

The frame structure may furthermore be directly connected to anchoring devices via one or more anchoring lines. Furthermore, one or more of the anchoring lines can be connected to a winch which by regulating the length of one or more of the anchoring lines can turn the frame structure in the horizontal plane.

The frame structure may furthermore or alternatively be provided with one or more powered devices exerting thrust in order to turn the frame structure in the horizontal plane.

The ballast body may furthermore be shaped as a container with an upward facing opening facilitating a filling of the container with a suitable ballast material from above. A suitable way of bringing the ballast material into place may be to dump it from a surface vessel when the frame structure is mounted hanging from the buoyancy elements and the empty ballast body is suspended from the frame structure via the connecting elements.

The frame structure may be constructed as a framework with truss members and nodes, where the nodes are formed as joints between the members.

An ideal framework has nodes that behave like joints, i.e. the nodes can take up small changes in angle between the truss members without exerting resistance against the angular deflections. The nodes according to the this embodiment thereby facilitate that bending moments will not be introduced into the truss members of the framework, in contrast to in a frame structure where one or more truss members run through a node or the truss members are rigidly connected in the nodes. By having joints that allow angular changes also out of the frame's plane, the great vertical forces from the buoyancy elements will not introduce bending stresses in the truss members of the framework, as the vertical forces from each pumping cylinder will be taken up directly by the vertical component of the force in the respective connecting element from the ballast body. A framework as described is assumed to be economically favorable compared to a frame structure with rigid nodes where the member stays have to be designed to withstand considerable bending moments in addition to the axial forces. To secure a linked node from yielding downward at the loss of lifting force from the attached buoyancy element, the framework can be provided with stoppers at the nodes. Also the frame structure may be provided with some minor net buoyancy so the node can be kept in place even without lifting force from the buoyancy element.

Furthermore, the pumping cylinders' connection to the frame structure may be rotatable about at least one mainly horizontal axis.

Different embodiments of the invention are described with reference to the enclosed figures, where

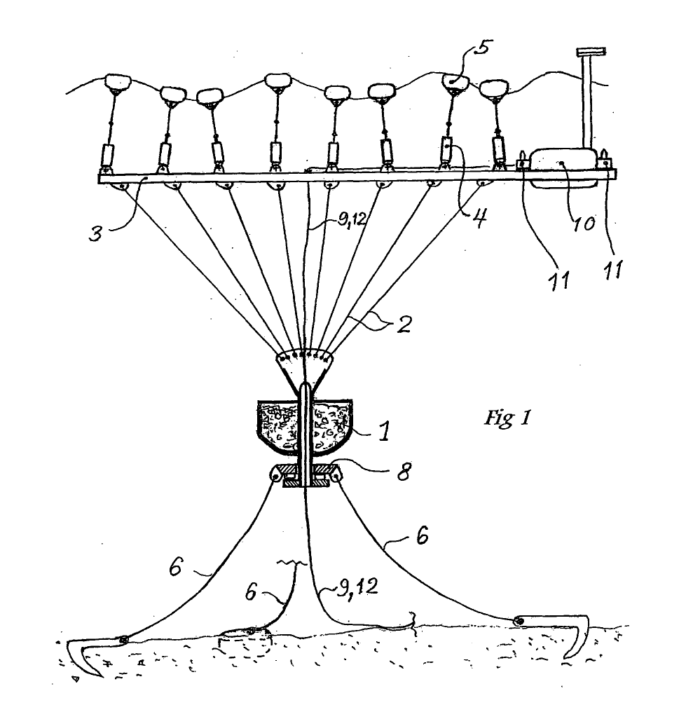

FIG. 1 shows a wave power plant according to the invention seen from the side.

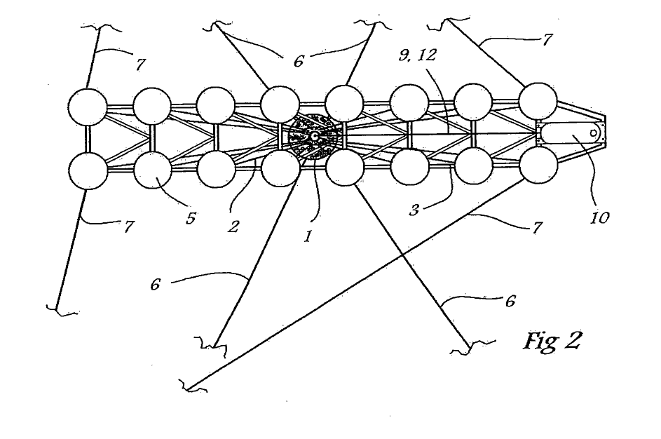

FIG. 2 shows a wave power plant according to the invention seen from above.

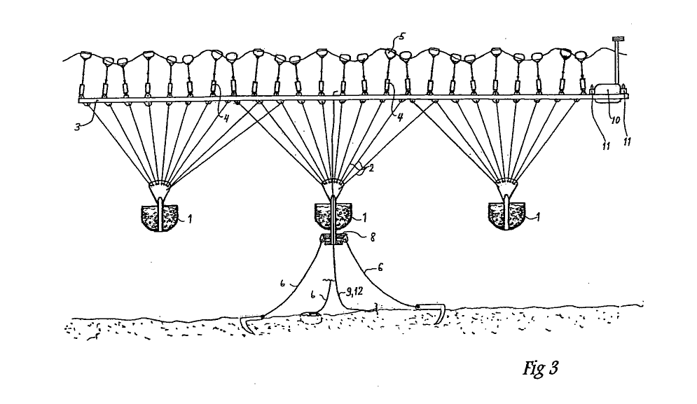

FIG. 3 shows an embodiment with three ballast bodies per frame structure.

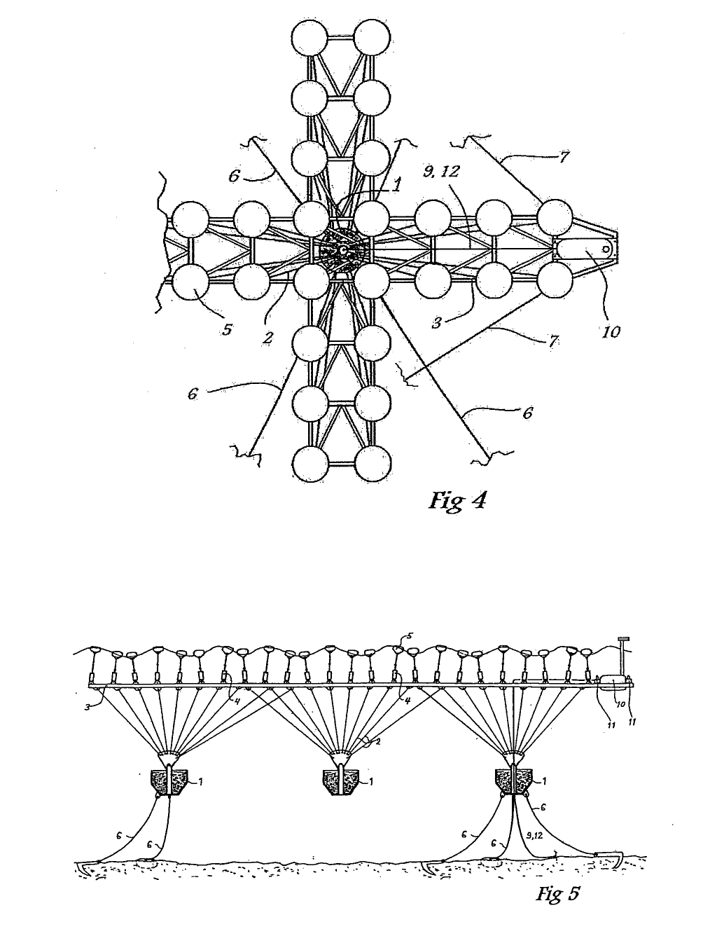

FIG. 4 shows a wave power plant where the frame structure is built in two directions perpendicular to each other.

FIG. 5 shows an embodiment of a wave power plant without controlled turning in the horizontal plane.

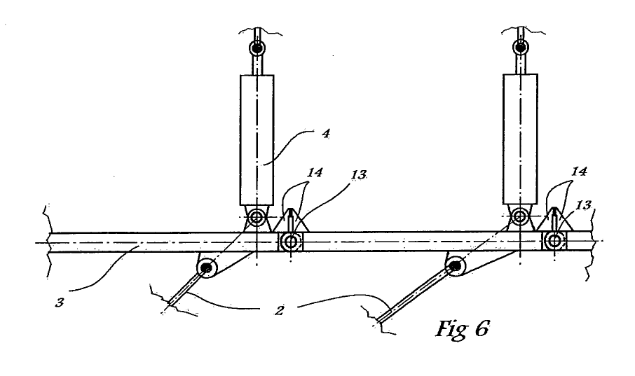

FIG. 6 shows a detail of thrusses and nodes in the frame structure with attached cable stays and pumping cylinders.

FIG. 1 shows the ballast body 1 suspended in a number of connecting elements, here shown as oblique cable stays 2 whose upper ends are connected to the frame structure 3.

The pumping cylinders 4 are connected to the frame 3 and the cylinders' piston rods are each connected to its respective buoyancy element 5. Slack anchoring lines 6 keep the wave power plant in a sufficiently accurate horizontal position. The anchoring lines are connected to the connecting body 8 which is rotatable with respect to the ballast body 1, thus allowing the wave power plant to obtain a desired orientation relative to the direction of propagation of the waves. A virtually naturally buoyant generator house 10 containing an electric power aggregate may be placed as shown with suitable connection devices 11 for easy connection and disconnection. Electrical power cables 9 and potentially communication cables 12 going from the wave power plant are led down through a tube centrally placed through the ballast body 1 and further through a central opening in the connecting body 8 and down to the sea bottom as shown.

FIG. 2 shows the wave power plant from above. Anchoring lines 7 for adjusting the position of the wave power plant are connected to anchors (not shown) at the sea bottom and are used to change the orientation of the wave power plant by means of winches (not shown).

FIG. 3 shows a wave power plant with three ballast bodies 1

FIG. 4 shows an example where the frame structure 3 with cable stays 2, pumping cylinders 4 and buoyancy elements 5 extends in directions perpendicular to each other. A frame structure 3 with more than one ballast body as shown in FIG. 3 and FIG. 5 may in a corresponding way have sections extending perpendicularly at each ballast body 1.

FIG. 5 shows an example of a wave power plant that has no controlled rotation in the horizontal plane. This will result in a simpler and less costly structure as the rotatable connecting element 8 and the anchor lines 7 with winches can be eliminated.

FIG. 6 shows a detail of the of the frame structure 3 with connected cable stays 2 and pumping cylinders 4 with joints 13 between the longitudinal main thrusses of the framework structure 3. Because of the joints 13, the bending moments from cables and pumping cylinders will not be transferred between the members of the frame 3, such that said members will have virtually pure axial load, and the retainers 14 prevent the linked node to yield downward by blocking further rotation of the bearing 13 in the direction related to downward movement.

1. Device for a floating wave power plant comprising a number of pumping cylinders (4) with a first and second end connected at the first end to a number of buoyancy elements (5) via connecting elements, which buoyancy elements (5) under the action of waves move the pumping cylinders in full or partial pumping strokes, characterized in that the pumping cylinders (4) at the second end are connected to a submerged frame structure (3), which frame structure (3) is connected to one or more submerged ballast bodies (1) via a number of connecting elements (2).

2. Device according to claim 1, characterized in that the mass of the one or more ballast bodies (1) and the dimensions of the frame structure (3) are suitably adapted to the number of connected buoyancy elements (5) such that the frame structure (3) obtains an inertia with respect to linear acceleration and angular acceleration, such that the frame structure (3) constitute a substantially stationary underwater restraint for the pumping cylinders (4).

3. Device according to claims 1-2, characterized in that at least one ballast body (1) is connected to anchoring devices on the sea bottom via anchoring lines (6).

4. Device according to claim 3, characterized in that the sea bottom anchored ballast body (1) is provided with a connecting element (8) which is further connected to the anchoring lines (6) which connecting element (8) is provided with a rotatable bearing such that the frame structure can rotate about a substantially vertical axis.

5. Device according to any one of the claims 1-4 characterized in that the frame structure (3) is connected to one or more anchoring lines (7) via one or more anchoring lines (7).

6. Device according to claim 5, characterized in that one or more of the anchoring lines (7) are connected to a winch which through varying the lengths of one or more of the anchoring lines (7) can turn the frame and thereby change its orientation in the horizontal plane. Device according to any one of the claims 1-4,

7. Device according to any one of the claims 1-4, characterized in that the frame structure is provided with one or more powered devices exerting thrust and thereby being able to turn the frame structure (3) and change its orientation in the horizontal plane.

8. Device according to any one of the preceding claims, characterized in that the ballast body (1) is shaped as a container with an upward facing opening which facilitates a filling of the ballast body (1) with a ballast material suitable for the purpose.

9. Device according to any one of the preceding claims, characterized in that the frame structure (3) is shaped as a framework with trusses and nodes where the nodes are formed as joints (13) between the trusses.

10. Device according to any one of the preceding claims, characterized in that the pumping cylinders' (4) connection to the frame structure (3) is rotatable about one or more axes substantially parallel to the frame's plane.
